(19) United States
(12) Patent Application Publication
(10) Pub. No.: US 2003/0048806 A1
(43) Pub. Date: Mar. 13, 2003

(54) Method for address allocation in ad-hoc networks

(76) Inventor: Jacobus Haartsen, Hardenburg (NL)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/079,180

(22) Filed: Feb. 19, 2002

Related U.S. Application Data
(60) Provisional application No. 60/318,812, filed on Sep. 13, 2001.

(51) Int. Cl. H04J 3/24

(52) U.S. Cl. 370/475; 370/329

(57) ABSTRACT

A common address space, which may be used for multiple purposes, is divided in two or more segments. The address space contains a list of device addresses for a group of entities, which may include devices, that share a common communication channel, such as a network. Each segment can correspond a special feature or function that corresponds to the entities whose address are stored in that segment. The address space is randomized by scrambling each address listed in the address space by an M-bit pseudo-random scrambling mask to offset each address individually. The pseudo-random scrambling mask is created when the network is established and is distributed among the network devices. When processing a received address, a device may use the same pseudo-random scrambling mask to descramble the address (depending on the scrambling function). After descrambling, any special features of the address are known and can be exploited.

### CROSS-REFERENCE TO RELATED APPLICATION

This application is related to, and claims priority from, U.S. Provisional Application No. 60/318,812, entitled “ADDRESS ALLOCATION IN AD-HOC NETWORKS,” filed on Sep. 13, 2001, the disclosure of which is incorporated herein by reference.

### BACKGROUND

The present invention is related to address selection in overlapping, uncoordinated networks and more particularly to preventing address contention in address list generation in overlapping, uncoordinated networks.

In modern wired and wireless communication networks, addressing is an essential element for proper data exchange. Each device or entity communicating in the network requires a unique identification to distinguish it from other entities in the network. Various addressing schemes are implemented to provide this identification function. In addition, logical links can be assigned addresses to separate different logical services. Finally, communication channels can be assigned addresses to define separate channels at the same communication medium.

For example, in the wireless communication system described in copending U.S. patent application Ser. No. 09/385,024, entitled “Resource Management In Uncoordinated Frequency Hopping System,” by J. C. Haartsen, filed Aug. 30, 1999, a system is described which defines different RF channels making use of a dynamic channel selection (DCS) scheme. Different groups of devices can independently establish their own wireless network by selecting a RF channel. The wireless networks are established in an ad-hoc fashion and are not coordinated with each other. Dynamic channel allocation schemes are used in the different networks, which have the potential of selecting the same RF channel.

This is particularly troublesome where an unlicensed, and therefore uncontrolled, band is used. One such band is the ISM (Industrial, Scientific and Medical) band at 2.4 GHz, which is globally available. The ISM band provides about 83.5 MHZ of radio spectrum.

The DCS scheme constantly monitors the RF band and selects the part of the band with the least interference. Two independent DCS schemes located in the same area are likely to select the same RF channel, since the communication environment they are monitoring are very similar, e.g., both may discover the presence of nearby interference from another network or system that jams part of the RF band. If the two systems select the same RF channel, there may be collisions between the systems since their transmissions are not coordinated. Even more damaging is when different networks share the same channel but there are no collisions; in that case, traffic exchanged in one network can erroneously be processed by devices of the other network.

To reduce the problems associated with two wireless networks operating in the same area that share the same RF channel, a high-speed channel identity (HS_ID) may be used. A network selects a HS_ID when the network is established. Each packet exchanged on the RF channel is preceded by this HS_ID. Only packets with this HS_ID are accepted by the devices belonging to the corresponding network. Since there is no coordination between different networks, the HS_ID is chosen randomly. However, there is a potential for different networks to select the same HS_ID.

The probability of a overlap is still relatively high, when considering the possibility of future widespread use. For example, when a N-bit HS_ID is used, the probability that two networks select the same HS_ID independently from each other is ½^{N}. Therefore, for an 8-bit HS_ID (N=8), the probability is 1/256, or about 0.4%. A scheme is needed to reduce this probability to reduce the possibility of collisions as uncoordinated networks, such as Bluetooth and its successors, increase in popularity and usage. Increasing the length N is one option; but since the identity length must be sent with each packet, this solution results in adding unnecessary overhead to the radio channel communication.

In addition to the channel addresses, device addresses are used to exchange data packets between specific devices. For example, it is very common that a packet contains a source address identifying the device that sent the packet, and a destination address, pointing to the device that receives the packet. To further reduce the probability of confusion between different independently created networks, device addresses can also be selected randomly. However, there are situations when random selection of device addresses cannot be used. For example, when the addresses are used to determine specific functions in addition to the device identity. More particularly, an address may be used to indicate certain characteristics, or special features, of the device, e.g., all devices with an even number transmit on even-numbered slots and all devices with an odd number transmit on odd-numbered slots. Alternatively, the address space may be used for multiple purposes, such as device identity and logical connection indication. In all these cases, the address has a special meaning and a random address selection cannot be used.

Accordingly, a method is needed in which address allocation appears to be random, to further reduce the probability of collisions with devices in neighboring networks, while still providing the ability to assign special meaning to the allocated addresses to represent special features or functions of the devices.

### SUMMARY

The present invention addresses these and other concerns. A common address space, which may be used for multiple purposes, is divided in two or more segments. The address space contains a list of device addresses for a group of entities, which may include devices, that share a common communication channel, such as a network. Each segment can correspond to a special feature or function that corresponds to the entities whose addresses are stored in that segment. Each address is M bits long. The address space is randomized by scrambling each address listed in the address space by an M-bit pseudo-random scrambling mask to offset each address individually. The pseudo-random scrambling mask is created when the network is established and is distributed among the network devices.

When processing a received address, a device may use the same pseudo-random scrambling mask to descramble the address (depending on the scrambling function). After descrambling, any special features of the address are known and can be exploited.

The address randomization scheme operates in addition to the N-bit random channel identity scheme discussed above. Accordingly, the probability of collisions between devices in uncoordinated networks is greatly reduced. More particularly, the probability that different networks use the same channel identity, of length N, and the same address allocation, of length M, for a particular device is ½^{(N+M)}. Therefore, for a 6-bit address (M=6), employing a 6-bit pseudo-random scrambling mask, and the same 8-bit HS_ID (N=8), the probability of a collision becomes 1/16,384, or about 0.006%.

According to one aspect, a method of allocating addresses among a group of entities sharing a common transmission medium, the addresses identifying each respective entity in the group, includes distributing, among the group of entities, at least one address mask; applying, within a transmitting entity of the group, using a scrambling function, a first address mask to an address portion of data transmitted by the transmitting entity of the group via the common transmission medium; and applying, within each receiving entity of the group, using a descrambling function, the first address mask, or a second address mask when the descrambling function differs from the scrambling function, the first or second address mask being applied to descramble the address portion of the transmitted data received by each receiving entity of the group to determine a corresponding actual address data.

According to another aspect, a method of communicating between two entities sharing a common transmission medium, includes sharing between the two entities, at least one address mask; applying, in a transmitting one of the two entities, using a scrambling function, a first address mask to an actual address data in an address portion of a data transmission to scramble the actual address data prior to transmission by the transmitting entity via the common transmission medium; and applying, within a receiving one of the two entities, using a descrambling function, the first address mask, or a second address mask when the descrambling function differs from the scrambling function, to the address portion of data received by the receiving entity to determine the corresponding actual address data.

According to yet another aspect, a computer program product for communicating between at least two entities sharing a common transmission medium includes a computer-readable storage medium having computer-readable program code means embodied in the medium. The computer-readable program code means includes logic that shares between the entities, at least one address mask; logic that applies, in a transmitting one of the entities, using a scrambling function, a first address mask to an actual address data in an address portion of a data transmission to scramble the actual address data prior to transmission by the transmitting entity via the common transmission medium; and logic that applies, within a receiving one of the entities, using a descrambling function, the first address mask, or a second address mask when the descrambling function differs from the scrambling function, to the address portion of data received by the receiving entity to determine the corresponding actual address data.

### BRIEF DESCRIPTION OF THE DRAWINGS

The above and other objects, features, and advantages of the present invention will become more apparent in light of the following detailed description in conjunction with the drawings, in which like reference numerals identify similar or identical elements, and in which:

FIG. 1 illustrates two independent groups of devices having established two independent wireless channels;

FIG. 2 illustrates a typical format for a packet exchanged on a wireless channel;

FIG. 3 illustrates conventional address space configurations that corresponding to the independent groups of devices in FIG. 1;

FIG. 4 illustrates scrambled address space configurations according to an embodiment of the present invention; and

FIG. 5 illustrates scrambled address space configurations according to another embodiment of the present invention.

### DETAILED DESCRIPTION

Preferred embodiments of the present invention are described below with reference to the accompanying drawings. In the following description, well-known functions and/or constructions are not described in detail to avoid obscuring the invention in unnecessary detail.

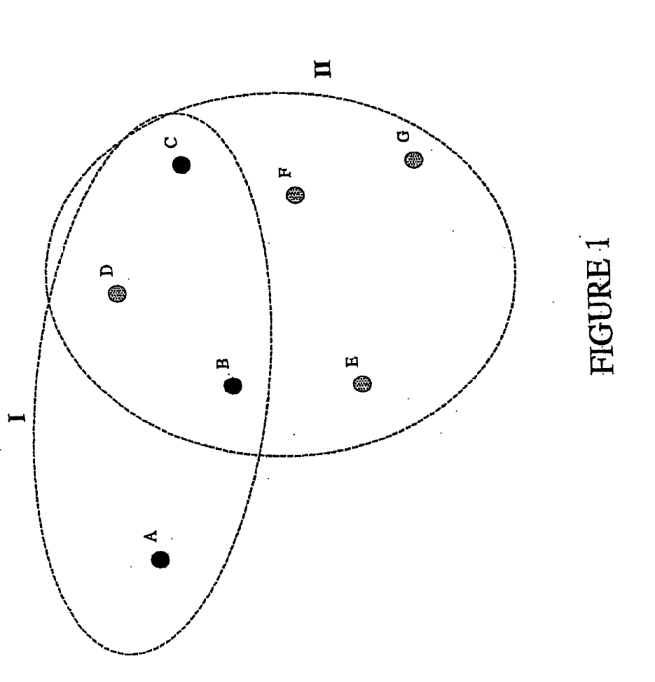

Turning to the drawings, FIG. 1 depicts two groups, such as networks, of wireless devices (Groups I and II) that are located within wireless communication range of each other (in vicinity). The two groups have each independently selected a corresponding wireless channel for communication. Group I consists of devices A, B and C, which use RF channel X. Group II consists of devices D E, F and G, which use RF channel Y. Both groups apply a dynamic channel selection scheme to select that part of the RF band that provides the least amount of interference for communication, and/or is least interfered. In this endeavor, both networks may have selected the same RF channel, i.e., X=Y.

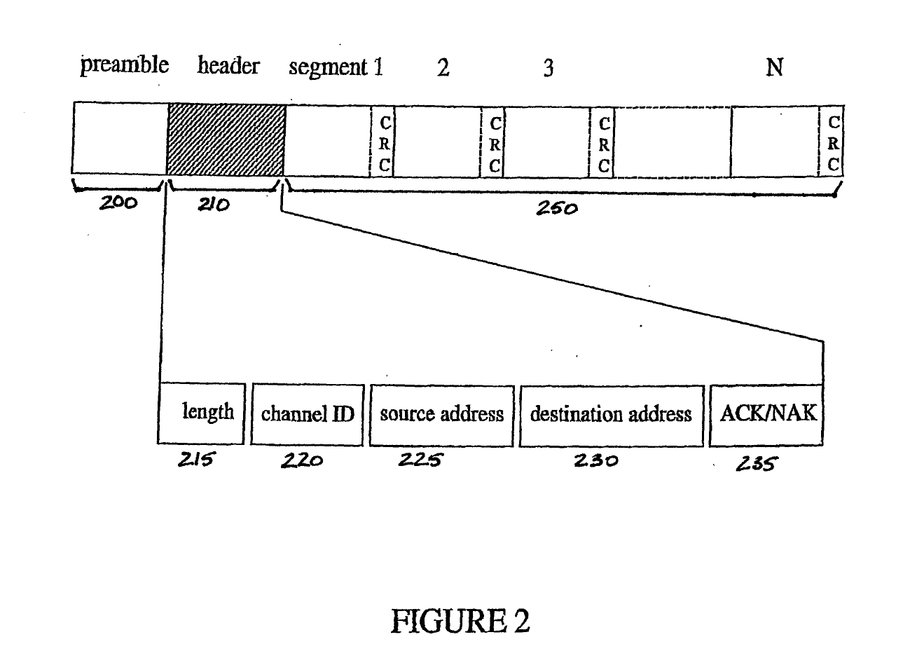

Data between the devices on each channel is typically exchanged in data packets. Since the devices in each group share a common channel, the packets include a source and destination address to indicate the sender and recipient, respectively. An example of a typical packet format is shown in FIG. 2. The packet may contain a preamble 200, which may contain a training sequence for receiver training, and a header 210, which contains source and destination addresses 225, 230 and additional control information, such as the packet length 215 and ACK/NAK information 235 of a retransmission scheme. The header may also contain a channel ID 220, such as HS_ID, which is a randomly selected number as discussed above. The packet also includes a payload 250 that contains the data to be transmitted. The payload may be segmented, as shown.

The data transmitted between the devices in the payload may vary in nature. For example the connection between devices A and B may carry synchronous traffic, such as voice, whereas asynchronous traffic may be exchanged between devices A, B, and C. Similarly, synchronous data may be transmitted between devices E and F, whereas devices D and G only support asynchronous data traffic. It is preferable in many cases to make a distinction between synchronous and asynchronous traffic in the address space. Such a distinction allows the address of the device to also represent a special feature of the device, i.e., whether synchronous data traffic is supported. For example, if certain time slots are allocated to the devices that support synchronous traffic, the address may correspond to a time slot. This can be accomplished, for example, by reserving the upper part of the address space for devices supporting synchronous traffic, while the lower part is reserved for devices not supporting synchronous traffic.

In another embodiment, the same address space may be used to identify both individual devices as individual (logical) links. In that case, devices may be allocated addresses beginning at the top of address space, whereas links are allocated addresses beginning at the bottom of the address space.

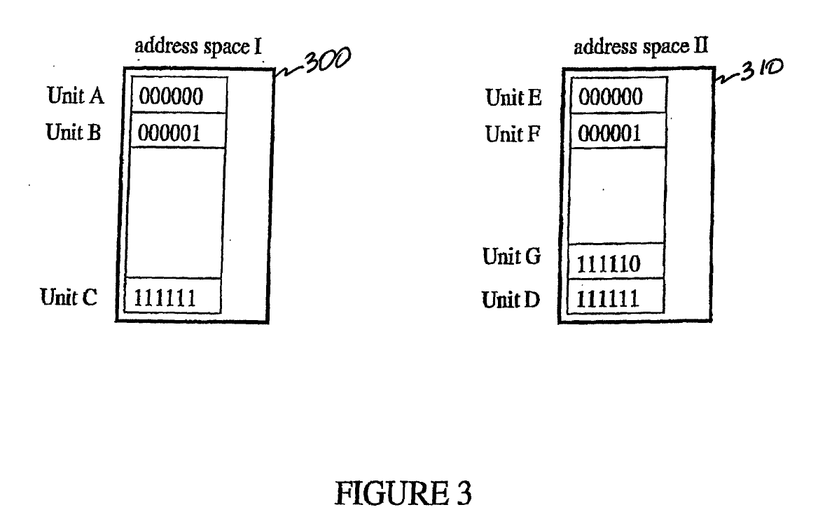

The conventional address spaces for devices A to G are shown in FIG. 3. The address spaces represent address data stored in a memory in an organized format to allow later retrieval. The memory storing the address data may be located in one or more of the devices A to G or may be located in some other entity communicating with the entities. An address space may be divided among several devices or duplicated in several devices. In addition, the memory may be larger then the address space and/or store the address space along with other data used for other purposes. Inversely, the address space may be larger than the memory. For example, a 16 bit address may be used, providing an address space of 216 possible addresses, while only 256 different addresses are required to identify the different devices. In this case, a 16 bit scrambling mask may still be used to randomize the address space (discussed further below), while the memory need only store the 256 addresses used.

Referring again to FIG. 3, address space I 300 corresponds to group I and address space II 310 corresponds to group II. Each address space includes a list of device addresses. Since the address lists for groups I and II, which use RF channels X and Y, respectively, are created independently using the same configuration of upper and lower address space, devices A and E will be assigned the same address. In the example shown, a 6-bit address is used. As more devices are added, more addresses are listed in the address space, either moving downward from the top for added devices supporting synchronous traffic, or moving upward from the bottom for added devices not supporting synchronous traffic. If a device leaves the network, its address is removed from the list and reused by the first added device having the same special feature. An entire block of addresses may also be reallocated to fill in the empty space in the list.

If the two groups, or networks, select the same RF channel (X=Y) and the same channel ID while they are in vicinity of each other, errors are likely. For example, when device A sends a packet that is intended for device B but also received by device F, device F may erroneously think it was sent by device E, since the packet header would contain the same channel ID 220, source address 225, and destination address 230. The probability of this occurring can be reduced considerably by scrambling the address spaces in each network by a pseudo-random number, called the scrambling mask. Scrambling can be done with any reversible bi-jective function. For example, a binary EXCLUSIVE-OR (XOR) operation may be used, which provides the following result when scrambling each bit of the device address:

0+0=0

0+1=1

1+0=1

1+1=0

For example, in FIG. 3, the address of device B is ‘000001’. When a binary XOR operation is applied bit by bit to the address using a scrambling mask of ‘011001’, the resulting new scrambled address for device B becomes ‘011000’. Applying the same scrambling mask in the same manner to the scrambled address for device B yields the original address ‘000001’ again. That is, since the reverse of the XOR function is the function itself, the same mask can be used to descramble the scrambled address at the destination to ascertain the true address of the source. Therefore, when the scrambling and descrambling involves the same function, there is no need for a separate descrambling and scrambling mask, since the masks would be the same.

It will be appreciated by one of ordinary skill in the art that, although an XOR operation is illustrated, many different scrambling techniques commonly known in the art may be employed. For example, a fixed number modulo 2^{M} may be added to each address to scramble the address and then subtracted to descramble the address. Another example could be to scramble an address by creating a permutation of the address by exchanging selected bits within the address, and to descramble the address by reversing the operation. It should also be noted that, while in the case of an XOR operation, the same mask may be used to both scramble and descramble, some techniques that involve complimentary masks for scrambling and descrambling may be employed. In such a case, both masks would be distributed when the group, or network, is established.

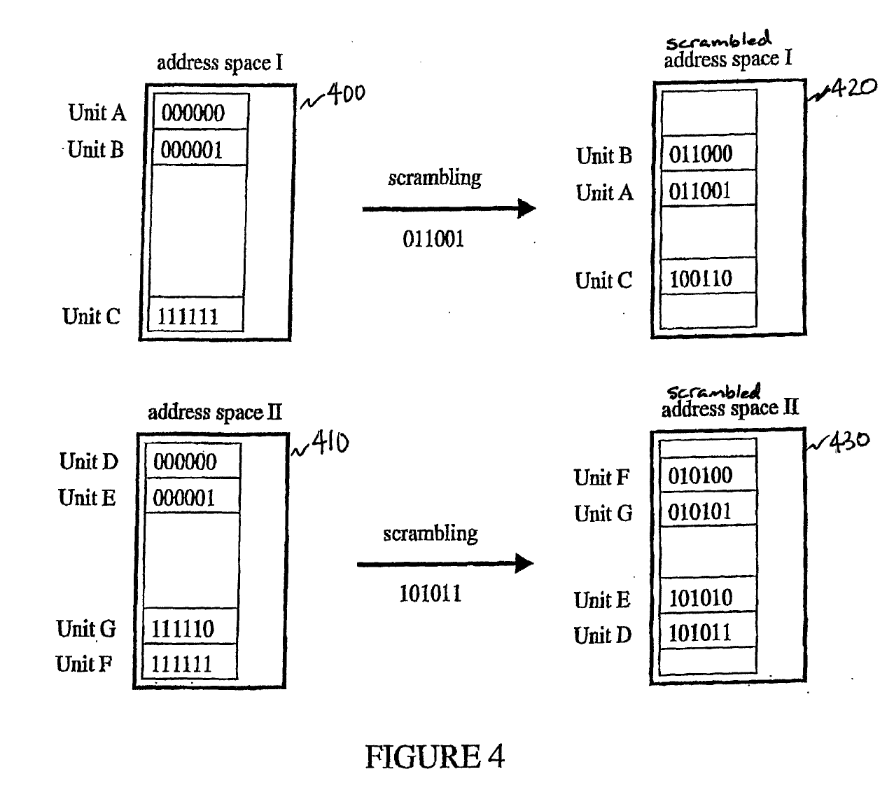

An example of two differently scrambled address lists is shown in FIG. 4. Address space I 400 corresponds to group I and address space II 410 corresponds to group II. Scrambled address spaces I 420 and II 430, which result from a different scrambling mask being applied using an XOR scrambling operation to the addresses in each respective address space, are also shown. The scrambling mask used for group I is ‘011001’, and for group II it is ‘101011’. The scrambled address spaces created using the different scrambling masks result in different address spaces 420 and 430 that contain different address lists. However, the original addresses can easily be retrieved by descrambling with the respective masks at the destination.

As the address lists become more populated, the probability of common addresses increases. However, the probability that these addresses also have the same corresponding special features decreases.

In the example illustrated by FIG. 4, the addresses of a device, in addition to identifying the device, correspond to one of two possible special features, synchronous and asynchronous. The synchronous addresses start from the top of the address list, the asynchronous from the bottom. In this way, addresses can be dynamically allocated for different special features without reserving a pool of addresses for each specific feature.

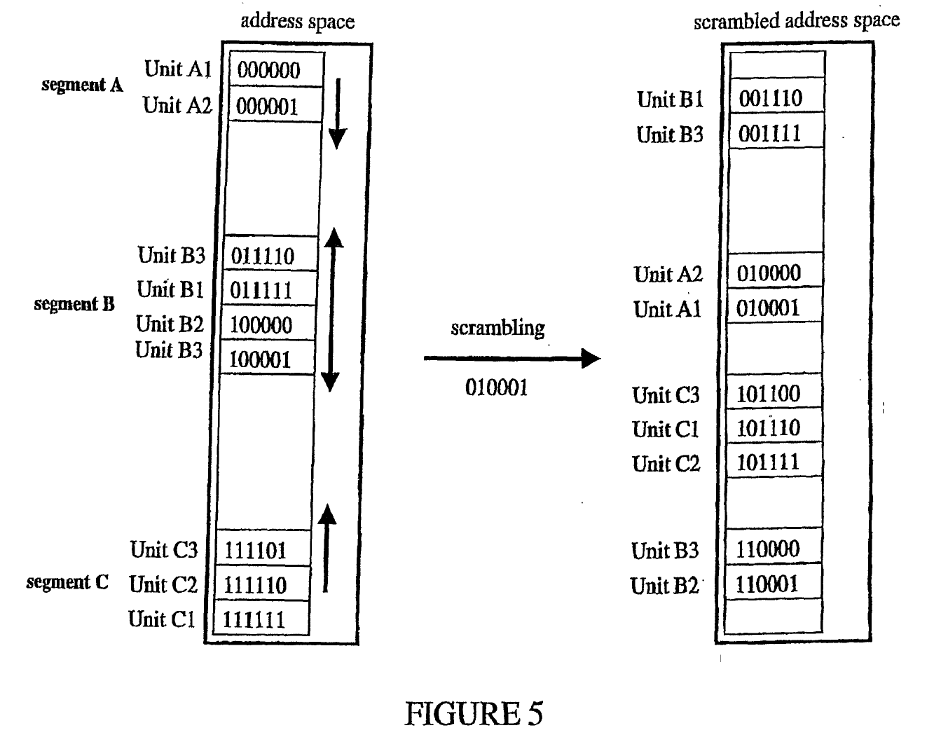

The same concept can be extended to correspond devices with more special features. For example, in FIG. 5, an example is shown for an address space with three special features, A, B, and C. Feature A corresponds to devices having addresses from the top down (segment A), feature C corresponds to devices having addresses from the bottom up (segment C), and feature B corresponds to devices having addresses starting at a predetermined reference address somewhere in the middle (address ‘011111’ is used by example). New devices with feature B are alternately allocated below and above the reference address. When a previously used address becomes available, due to a service being discontinued or a device leaving the group, the available address is either used by a new device or service entering the group, or other devices/services in the list are reallocated the available addresses.

It will be understood that the address space can be divided into even more segments, each segment corresponding to a certain group of addresses reserved for a specific group of devices, services, or other special features. The segment sizes are preferably variable. That is, they grow and shrink depending on whether services are added or removed. The address space is dynamically shared by several services without permanently allocating a fixed number of addresses for each service. Scrambling is used to (pseudo-) randomize the address space to minimize ambiguities in areas where multiple independent systems use the same address space. In particular, in cases where the address space is sparsely used (i.e., many more addresses are available than used), the probability that different networks apply the same addresses (in a similar fashion) becomes rather small.

When the boundaries between two segments meet, additional addresses can only be issued using the space at the opposite boundary (if there is one). This can only be accomplished if a segment has two boundaries, as, for example, segment B in FIG. 5.

It should be emphasized that although the invention has been described above with reference to a RF channel, any communication medium may be used within the scope of the present invention. Additionally, the invention is not limited to the RF spectrum. The term ‘channel’ is meant in its broadest sense. For example, a channel may be, but is not limited to: one or more time periods for communication, such as in time division based communication; a specific frequency range, such as in frequency division based communication; a frequency hopping scheme, such as that employed in Bluetooth; one or more codes, such as in code division based communication; or any combination of the above.

Although described with reference to a communication system, it will be appreciated by those of ordinary skill in the art that this invention can be embodied in other specific forms without departing from its essential character. For example, the invention may be used in any multi-processor system. The embodiments described above should therefore be considered in all respects to be illustrative and not restrictive.

It will be appreciated that the steps of the methods illustrated above may be readily implemented either by software that is executed by a suitable processor or by hardware, such as an application-specific integrated circuit (ASIC).

The various aspects of the invention have been described in connection with a number of exemplary embodiments. To facilitate an understanding of the invention, many aspects of the invention were described in terms of sequences of actions that may be performed by elements of a computer system. For example, it will be recognized that in each of the embodiments, the various actions could be performed by specialized circuits (e.g., discrete logic gates interconnected to perform a specialized function), by program instructions being executed by one or more processors, or by a combination of both.

Moreover, the invention can additionally be considered to be embodied entirely within any form of computer readable storage medium having stored therein an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiment may be referred to herein as “logic configured to” perform a described action, or alternatively as “logic that” performs a described action.

It should also be emphasized that the terms “comprises” and “comprising”, when used in this specification as well as the claims, are taken to specify the presence of stated features, steps or components; but the use of these terms does not preclude the presence or addition of one or more other features, steps, components or groups thereof.

Various embodiments of Applicants' invention have been described, but it will be appreciated by those of ordinary skill in this art that these embodiments are merely illustrative and that many other embodiments are possible. The intended scope of the invention is set forth by the following claims, rather than the preceding description, and all variations that fall within the scope of the claims are intended to be embraced therein.

What is claimed is:

1. A method of allocating addresses among a group of entities sharing a common transmission medium, the addresses identifying each respective entity in the group, the method comprising the steps of:
distributing, among the group of entities, at least one address mask;
applying, within a transmitting entity of the group, using a scrambling function, a first address mask to an address portion of data transmitted by the transmitting entity of the group via the common transmission medium; and
applying, within each receiving entity of the group, using a descrambling function, the first address mask, or a second address mask when the descrambling function differs from the scrambling function, the first or second address mask being applied to descramble the address portion of the transmitted data received by each receiving entity of the group to determine a corresponding actual address data.

2. The method of claim 1, wherein the scrambling and descrambling functions are the same, only the first address mask is distributed among the group, and the first address mask is used to descramble the address portion of the transmitted data.

3. The method of claim 2, wherein the scrambling and descrambling functions are both EXCLUSIVE-OR (XOR) operations.

4. The method of claim 1, wherein the scrambling and descrambling functions are not the same, the first and second address masks are distributed among the group, and the second address mask is used to descramble the address portion of the transmitted data.

5. The method of claim 1, wherein the group of entities comprise a wireless network.

6. The method of claim 5, wherein the wireless network is an ad-hoc wireless network, wherein the common transmission medium includes at least one channel established in an uncoordinated way.

7. The method of claim 5, wherein the common transmission medium includes a plurality of channels and dynamic channel selection is used.

8. The method of claim 1, wherein the common transmission medium includes at least one channel defined by a frequency hopping scheme.

9. The method of claim 1, wherein at least one of the entities stores a list of the actual address data, the list being organized in segments with each segment implying a special feature on the entities corresponding to the actual address data stored in the respective segment.

10. The method of claim 9, wherein the segments include a segment for entities supporting synchronous data transfer and a segment for entities not supporting synchronous data transfer.

11. A method of communicating between two entities sharing a common transmission medium, the method comprising the steps of:
sharing between the two entities, at least one address mask;
applying, in a transmitting one of the two entities, using a scrambling function, a first address mask to an actual address data in an address portion of a data transmission to scramble the actual address data prior to transmission by the transmitting entity via the common transmission medium; and
applying, within a receiving one of the two entities, using a descrambling function, the first address mask, or a second address mask when the descrambling function differs from the scrambling function, to the address portion of data received by the receiving entity to determine the corresponding actual address data.

12. The method of claim 11, wherein the scrambling and descrambling functions are the same, only the first address mask is shared between the two entities, and the first address mask is used to descramble the address portion of the transmitted data.

13. The method of claim 12, wherein the scrambling and descrambling functions are both EXCLUSIVE-OR (XOR) operations.

14. The method of claim 11, wherein the scrambling and descrambling functions are not the same, the first and second address masks are shared between the two entities, and the second address mask is used to descramble the address portion of the transmitted data.

15. The method of claim 11, wherein the two entities comprise a wireless network.

16. The method of claim 15, wherein the wireless network is an ad-hoc wireless network, wherein the common transmission medium includes at least one channel established in an uncoordinated way.

17. The method of claim 15, wherein the common transmission medium includes a plurality of channels and dynamic channel selection is used.

18. The method of claim 11, wherein the common transmission medium includes at least one channel defined by a frequency hopping scheme.

19. The method of claim 11, wherein at least one of the two entities stores a list of the actual address data, the list being organized in segments with each segment implying a special feature on the entities corresponding to the actual address data stored in the respective segment.

20. The method of claim 19, wherein the segments include a segment for entities supporting synchronous data transfer and a segment for entities not supporting synchronous data transfer.

21. A computer program product for communicating between at least two entities sharing a common transmission medium, the computer program product comprising:
a computer-readable storage medium having computer-readable program code means embodied in said medium, said computer-readable program code means including:
logic that shares between the entities, at least one address mask;
logic that applies, in a transmitting one of the entities, using a scrambling function, a first address mask to an actual address data in an address portion of a data transmission to scramble the actual address data prior to transmission by the transmitting entity via the common transmission medium; and
logic that applies, within a receiving one of the entities, using a descrambling function, the first address mask, or a second address mask when the descrambling function differs from the scrambling function, to the address portion of data received by the receiving entity to determine the corresponding actual address data.

22. The computer program product of claim 21, wherein the scrambling and descrambling functions are the same, only the first address mask is shared between the at least two entities, and the first address mask is used to descramble the address portion of the transmitted data.

23. The computer program product of claim 22, wherein the scrambling and descrambling functions are both EXCLUSIVE-OR (XOR) operations.

24. The computer program product of claim 21, wherein the scrambling and descrambling functions are not the same, the first and second address masks are shared between the at least two entities, and the second address mask is used to descramble the address portion of the transmitted data.
